(19) United States
(12) Patent Application Publication
(10) Pub. No.: US 2022/0320725 A1
(43) Pub. Date: Oct. 6, 2022

(54) ANTENNA APPARATUS AND METHOD

(71) Applicant: Nokia Solutions and Networks Oy, Espoo (FI)

(72) Inventors: Mikko KOMULAINEN, Oulu (FI); Juha Samuel Hallivuori, Tampere (FI); Willem Verbiest, Sint-Gillis-Waas (BE); Natalia Dementieva, Antwerp (BE); Nikolaus Singer, Gablitz (AT); Nikolas Olaziregi, Antwerp (BE); Ronny Peeters, Hoboken (BE)

(73) Assignee: Nokia Solutions and Networks Oy, Espoo (FI)

(21) Appl. No.: 17/710,007

(22) Filed: Mar. 31, 2022

(30) Foreign Application Priority Data
Mar. 31, 2021 (FI) 20215397

(51) Int. Cl. H01Q 3/01; H01Q 25/00; H01Q 15/16

(52) U.S. Cl. CPC H01Q 3/01; H01Q 25/002; H01Q 15/16

(57) ABSTRACT

Aspects and embodiments described may provide a reconfigurable antenna apparatus and method of alignment of such a reconfigurable antenna apparatus. The apparatus may comprise antenna apparatus components reconfigurable between: a mode of operation which supports a radio communication beam having a first beamwidth; and a mode of operation which supports a radio communication beam having a second beamwidth. The first beamwidth may be several times the width of the second beamwidth. Aspects and embodiments recognise that such a reconfigurable antenna apparatus may support efficient alignment methods in which a first, coarse, alignment scan may be performed across a broad field of view, and the results of that alignment scan can be used to allow a finer second scan within a reduced field of view determined by the first scan.

### CROSS-REFERENCE TO RELATED APPLICATIONS

This application claims priority to Finnish Application No. 20215397 filed Mar. 31, 2021, the entire contents of which are incorporated herein by reference.

### TECHNOLOGICAL FIELD

Various example embodiments relate to a reconfigurable antenna apparatus and method of alignment of such a reconfigurable antenna apparatus.

### BACKGROUND

Wireless communication systems are known. Typically users of such networks require access to high-quality services at any time and location and hence create substantial traffic. Wireless communication networks are adapting to provide sufficient capacity and satisfactory data rates. One possible adaptation comprises increasing available frequency bandwidth, for example, by using regions of the electromagnetic spectrum which may not have typically been used for cellular radio communication. Such regions include, for example, a “Super High Frequency” SHF region (3-10 GHz), 5G-New Radio bands and millimetre-wave (mm-wave) frequencies.

FSPL (Free Space Path Loss) increases as distance increases between a transmit antenna and a receive antenna and/or the FSPL increases as operational frequency increases (or as wavelength decreases). As a result, use of high frequencies typically results in high path loss, together with deep shadowing because of weak diffraction reflection. Path loss can be compensated for by providing a signal at high gain, and/or providing directed beam energy.

Providing a practical deployment suited to a frequency subject to significant path loss and which supports increased user demands presents various challenges. It is desired to address some of those challenges.

### BRIEF SUMMARY

The scope of protection sought for various embodiments of the invention is set out by the independent claims. The examples and features, if any, described in this specification that do not fall under the scope of the independent claims are to be interpreted as examples useful for understanding various embodiments of the invention.

According to various, but not necessarily all, embodiments of the invention there is provided an apparatus, comprising antenna apparatus components reconfigurable between: a mode of operation which supports a radio communication beam having a first beamwidth; a mode of operation which supports a radio communication beam having a second beamwidth; wherein the first beamwidth is several times the width of the second beamwidth; and wherein the apparatus further comprises an assembly configured to adjust a direction of transmission of at least one of the radio communication beams generable by the apparatus.

The apparatus may be such that the antenna components are configured, dimensioned or formed in a manner which supports operation with radio-frequency beams used to support communication networks.

The apparatus may be such that the first beamwidth is an order of magnitude greater than the width of the second beamwidth.

The apparatus may be such that the antenna apparatus components used to support the radio communication beams having the first and second beamwidth comprise common antenna apparatus components.

The apparatus may be such that the common components are physically reconfigurable to effect the switch between the first and second beamwidth.

The apparatus may be such that the common components comprise an antenna feed.

The apparatus may be such that the antenna apparatus components comprise: an antenna feed; and at least one reflector configured to reflect a beam receivable from the antenna feed.

The apparatus may be such that the antenna feed comprises a plurality of antenna elements configured to form the antenna feed.

The apparatus may be such that the antenna feed comprises a one-dimensional array of antenna elements.

The apparatus may be such that the antenna feed comprises a two-dimensional feed array of antenna elements.

The apparatus may be such that adjusting the direction of transmission of at least one of the radio communication beams generable by the apparatus comprises physically adjusting positioning of one or more of the antenna apparatus components.

The apparatus may be such that adjusting the direction of transmission of at least one of the radio communication beams generable by the apparatus comprises: adjusting a direction of a beam generable by an antenna feed.

The apparatus may be such that the assembly configured to adjust the direction of transmission of at least one of the radio communication beams generable by the apparatus comprises an antenna feed array.

The apparatus may be such that the assembly configured to adjust the direction of transmission of at least one of the radio communication beams generable by the apparatus comprises a reflector.

The apparatus may be such that the apparatus comprises a positioning assembly, configured to control the relative positions of the antenna feed and reflector.

The apparatus may be such that the at least one reflector has a focal distance and the antenna feed is locatable that focal distance away from at least one of the reflectors.

The apparatus may be such that reflector is dimensioned to redirect a radio-frequency beam having a frequency above 3 GHz received from the antenna feed.

The apparatus may be such that the reflector is dimensioned to redirect a radio-frequency beam having a frequency between 30 and 300 GHz received from the antenna feed.

The apparatus may be such that the reflector is dimensioned to redirect a radio-frequency beam having a frequency between 3 and 300 GHz received from the antenna feed.

The apparatus may be such that the positioning assembly is configured to reconfigure the relative positions of the antenna feed and reflector from a configuration which supports a radio communication beam having the first beamwidth and in which the at least one reflector is prevented from reflecting the beam receivable from the antenna feed; to a configuration which supports a radio communication beam having the second beamwidth and in which the reflector is arranged to reflect the beam receivable from the antenna feed.

The apparatus may be such that the positioning assembly is configured to rotate at least one of: the antenna feed and at least one reflector with respect to each other.

The apparatus may be such that the positioning assembly is configured to adjust relative positioning of: at least one of the antenna feed and at least one reflector with respect to each other.

The apparatus may be such that the positioning assembly is configured to adjust relative distance between: at least one of the antenna feed and at least one reflector with respect to each other.

The apparatus may be such that the at least one reflector comprises a parabolic reflector.

The apparatus may be such that the at least one reflector comprises a first reflector configurable to reflect a beam receivable from the antenna feed toward the parabolic reflector.

The apparatus may be such that the assembly comprises a mount to which the antenna apparatus components are mounted to be rotatable about an axis, such that the radio communication beam creatable by the components is adjustable.

The apparatus may be such that the antenna apparatus components are mounted to be rotatable about an axis, such that a direction of transmission of the radio communication beam creatable by the components is moveable.

According to a further aspect of the invention there may be provided a method, comprising: providing antenna apparatus components and reconfiguring those components between: a mode of operation which supports a radio communication beam having a first beamwidth; a mode of operation which supports a radio communication beam having a second beamwidth; wherein the first beamwidth is several times the width of the second beamwidth

According to a further aspect of the invention there may be provided a method, comprising:

determining that a radio communication beam supportable by antenna apparatus requires aligning with a further radio communication beam;

performing two or more first signal measurements across a first field of view using the antenna apparatus, the first signal measurements comprising a position of the radio communication beam supportable by the antenna apparatus within the first field of view and an indication of a characteristic of a communication link supportable by the radio communication beam supportable by the antenna apparatus and the further radio communication beam in that position;

determining, from the first signal measurements, the position at which the characteristic indicates a communication link supportable by the radio communication beam supportable by the antenna apparatus and the further radio communication beam is best;

reconfiguring the antenna apparatus from a mode of operation which supports a radio communication beam having a first beamwidth to a mode of operation having a second beamwidth, therein the first beamwidth is several times the width of the second beamwidth;

performing two or more second signal measurements across a second field of view using the antenna apparatus, the second signal measurements comprising a position of the radio communication beam supportable by the antenna apparatus within the second field of view and an indication of a characteristic of a communication link supportable by the radio communication beam supportable by the antenna apparatus and the further radio communication beam in that position; wherein the second field of view is determined by the position at which the characteristic a communication link supportable by the radio communication beam supportable by the antenna apparatus and the further radio communication beam is best whilst in the mode of operation which supports a radio communication beam having the first beamwidth and the first beamwidth;

determining, from the second signal measurements, the position at which the characteristic of a communication link supportable by the radio communication beam supportable by the antenna apparatus whilst in the mode of operation which supports a radio communication beam having the second beamwidth and the further radio communication beam is best; and

aligning the radio communication beam having the second beamwidth supportable by antenna apparatus to that position.

The apparatus may be such that the characteristic may comprise an indication of signal strength. The apparatus may be such that the characteristic may comprise an indication of signal quality. The characteristic may comprise a combined indicator determined from an indication of signal strength and signal quality.

The apparatus may be such that the first signal measurements comprise a series of stepped signal measurements, wherein each first signal measurement comprises a measurement relating to a radio communication beam having a sector of the field of view covered by a beamwidth adjacent to another sector of the field of view covered by a beamwidth and to which a different first signal measurement applies.

The apparatus may be such that the first signal measurements comprise a series of stepped overlapping signal measurements, wherein each first signal measurement comprises a measurement relating to a radio communication beam having a sector of the field of view covered by a beamwidth which at least partially overlaps another sector of the field of view covered by a beamwidth and to which a different first signal measurement applies.

The apparatus may be such that the first signal measurements comprise a continuous scan across the field of view forming a series of signal measurements, wherein each first signal measurement comprises a measurement relating to a radio communication beam having a sector of the field of view covered by a beamwidth adjacent to another sector of the field of view covered by a beamwidth and to which a different first signal measurement applies.

The apparatus may be such that the second signal measurements comprise a series of stepped signal measurements, wherein each second signal measurement comprises a measurement relating to a radio communication beam having a sector of the second field of view covered by a second beamwidth adjacent to another sector of the second field of view covered by a second beamwidth and at which a different second signal measurement is made.

The apparatus may be such that if it is determined, from the first signal measurements, that the position at which the indication of a characteristic of a communication link supportable by the radio communication beam supportable by the antenna apparatus is best reveals no maximum or no signal is detected; the two or more second signal measurements are performed across the first field of view.

The apparatus may be such that the first field of view comprises a 360 degree field of view in a horizontal azimuth. The apparatus may be such that the first field of view comprises a 180 degree field of view in a horizontal azimuth.

Further particular and preferred aspects are set out in the accompanying independent and dependent claims. Features of the dependent claims may be combined with features of the independent claims as appropriate, and in combinations other than those explicitly set out in the claims.

Where an apparatus feature is described as being operable to provide a function, it will be appreciated that this includes an apparatus feature which provides that function or which is adapted or configured to provide that function.

### BRIEF DESCRIPTION

Some example embodiments will now be described with reference to the accompanying drawings in which:

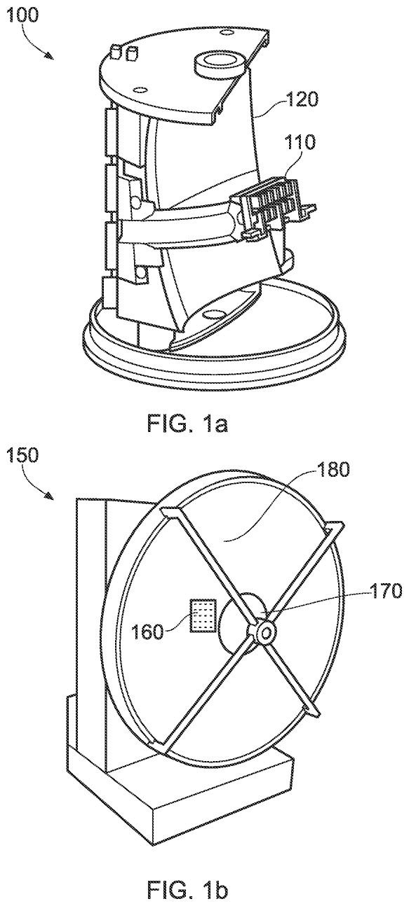

FIG. 1a and FIG. 1b illustrate main components of example high gain mm-wave antenna solutions for 24.0-43.5 GHz New Radio (NR);

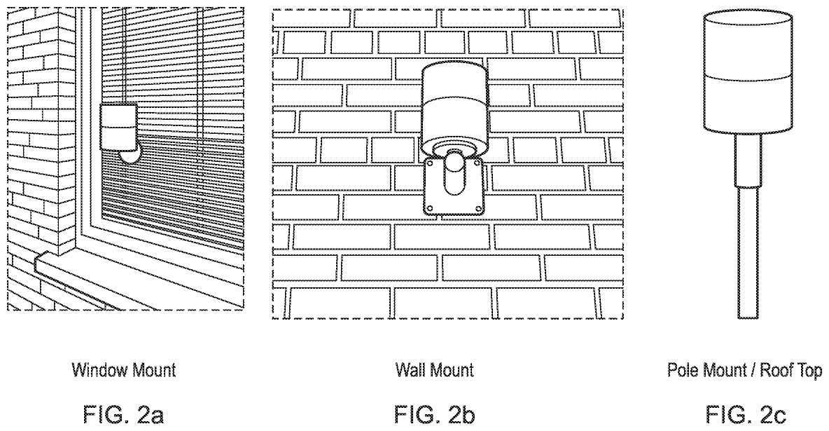

FIGS. 2a to 2c are photographs of fixed wireless access devices for deployment at a location to provide a region of radio coverage;

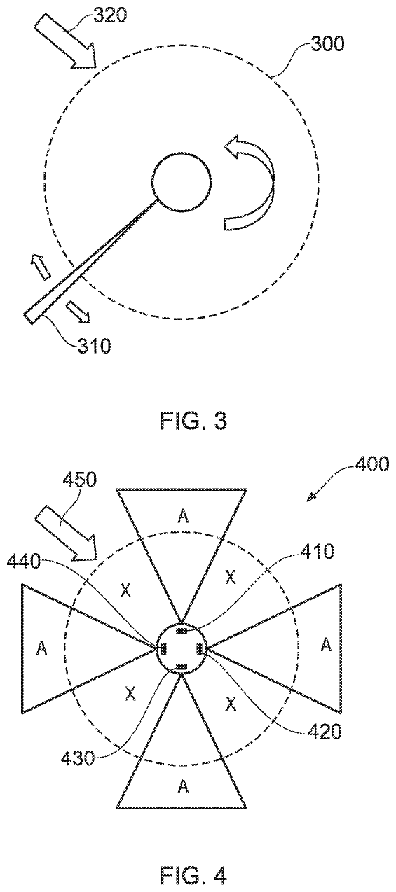

FIG. 3 illustrates schematically a plan view of antenna apparatus such as that shown in FIGS. 1a and 1b, located within a device such as that shown in FIGS. 2a to 2C;

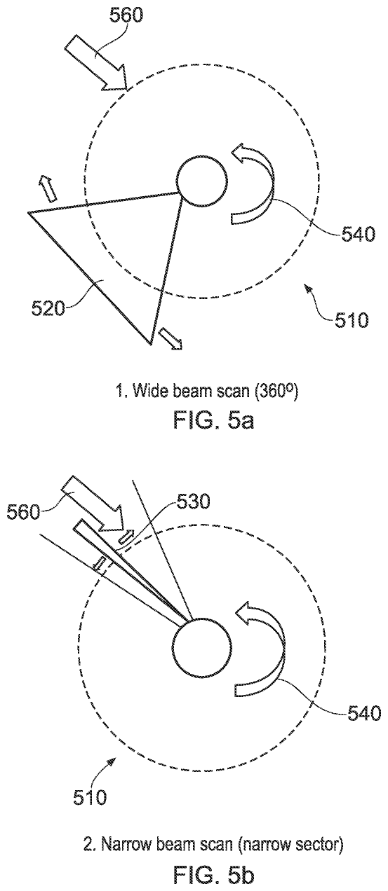

FIG. 4 illustrates schematically main components of an example antenna apparatus;

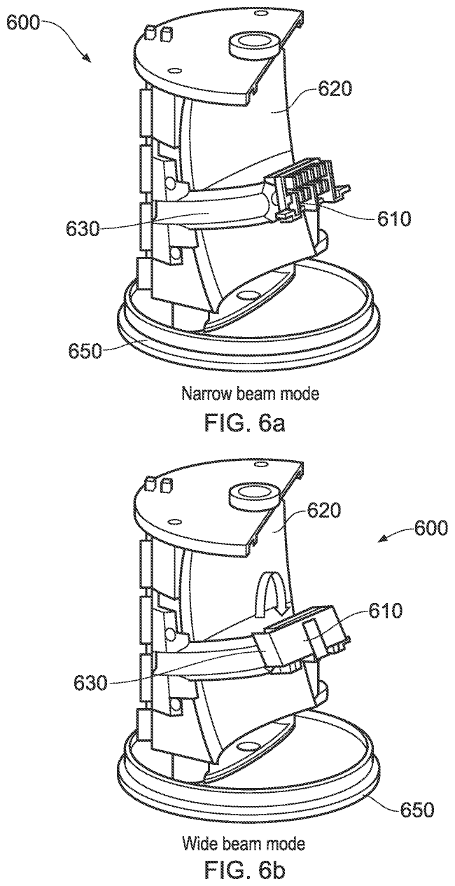

FIGS. 5a and 5b illustrate schematically a two-phase alignment scan method of some arrangements;

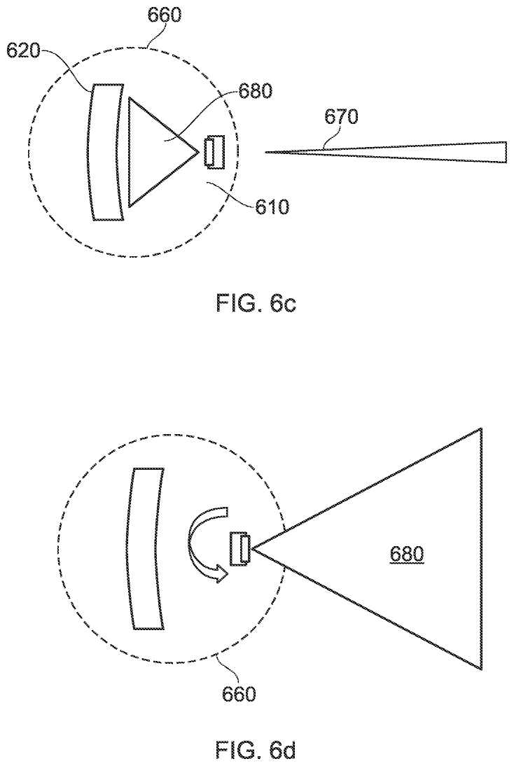

FIGS. 6a and 6b illustrate the main components of one possible example hardware implementation of reconfigurable antenna apparatus;

FIGS. 6c and 6d are schematic representations of configurations of components within a device enclosure and resulting beam patterns of a hardware antenna according to the examples shown in FIGS. 6a and 6b respectively;

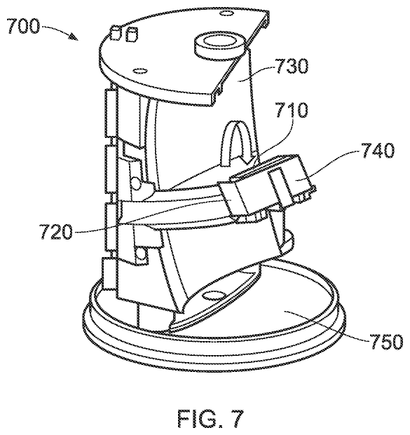

FIG. 7 illustrates the main components of one possible example hardware implementation of antenna apparatus which can support the alignment methodology of some described arrangements;

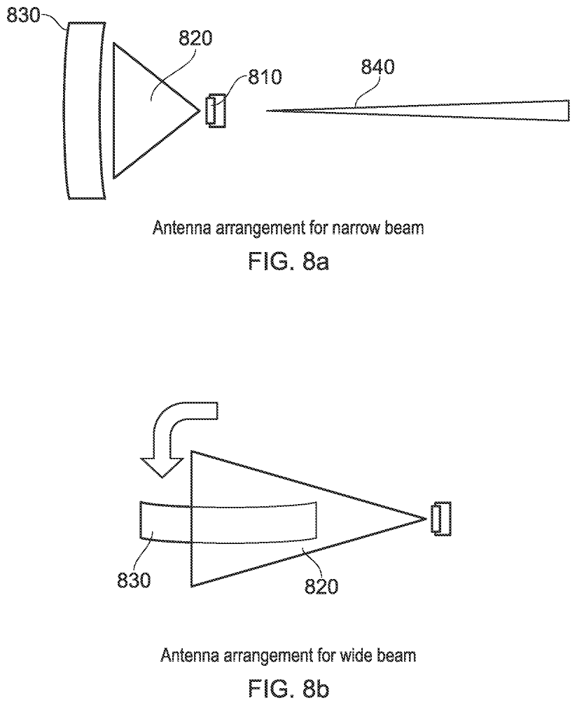

FIGS. 8a and 8b are schematic representations of configurations of antenna components within a device enclosure and resulting beam patterns;

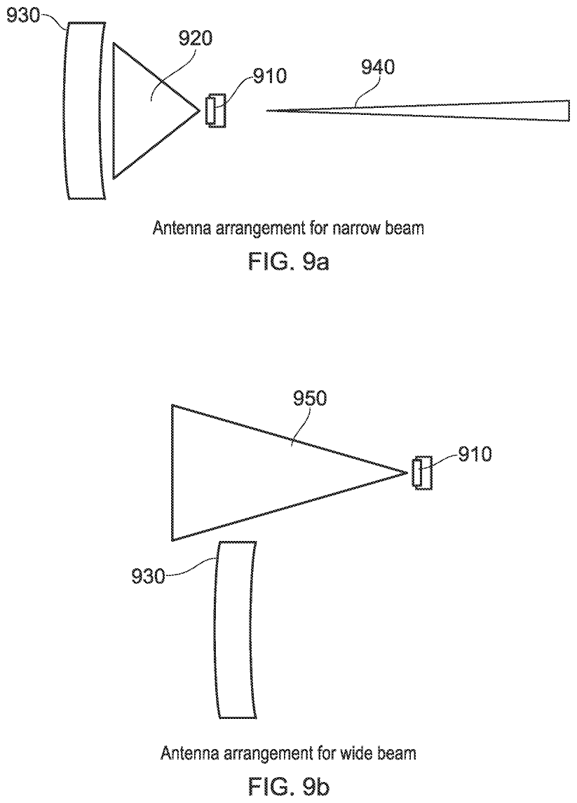

FIGS. 9a and 9b are schematic representations of configurations of antenna components within a device enclosure and resulting beam patterns;

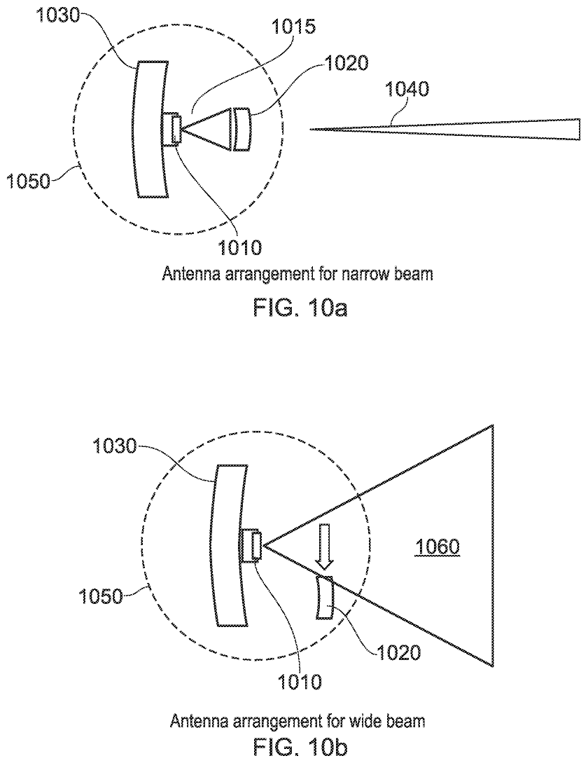

FIGS. 10a and 10b are schematic representations of configurations of antenna components within a device enclosure and resulting beam patterns; and

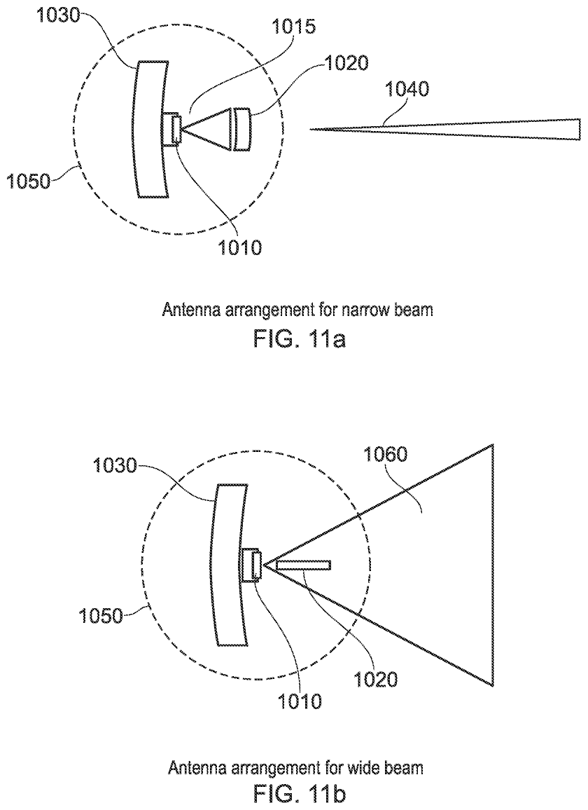

FIGS. 11a and 11b are schematic representations of configurations of antenna components within a device enclosure and resulting beam patterns.

### DETAILED DESCRIPTION

Before discussing the example embodiments in any more detail, first an overview will be provided. As described above, increasing demand on wireless communication networks has led to adaptation and development, including consideration of traditionally unused portions of radio spectrum to support communication. One particular area of development relates to use of frequencies outside those which may typically have been used in support of cellular communication. Use of frequencies above 3 GHz may be such that their use is subject to significant path loss. FSPL (Free Space Path Loss) increases as operational frequency increases (or as wavelength decreases). Use of Extremely High Frequency (EHF) frequencies (30-300 GHz) and some regions of the Ultra High Frequency (UHF) and Super High Frequency (SHF) bands may result in particular issues related to path loss.

One of the issues with, for example, millimetre wave communication techniques is that at such high frequencies, high path loss occurs. One mechanism to overcome high path loss is transmission at high power. Where high power transmission may be difficult or inappropriate, it is possible to ensure that transmissions are made by an antenna operating to have a narrow beam so that the energy within the beam is very directional and the radiation pattern has a much greater peak antenna gain relative to an omnidirectional antenna radiation pattern.

One possible application for millimetre wave communication networks is that of provision of an alternative to a traditional wired or optical broadband connection. That is to say, it is possible that millimetre wave 5G deployments can be used to provide one or more cells providing radio coverage at a customer premises which supports very high and/or very reliable data transmission between one or more base stations and users within a region of coverage provided or supported by such a base station. It will be appreciated that when providing a region of coverage or cell of coverage, a base station may be required to provide a cell which has, for example, 180°-360° coverage in the horizontal plane and at least 90° of protection of coverage in the vertical plane, thereby providing users having network connectable devices located within that field of view or coverage area with a strong communication link with a base station.

It will be appreciated that use of narrow beams or directional beams to support communication with users within a potential region of coverage using microwave millimetre wave technology may be difficult. Narrow beam use results in a small area in which communication links with users can be established and maintained, but are required in relation to mmW approaches to counteract high path loss and shadowing effects in electromagnetic wave propagation. It will be appreciated that a very focused m or directional beam operates to concentrate the energy and ensure a reliable and strong communication link between communicating entities can be established. Such a focused beam can be obtained by careful placement, for example, of a reflector and feed. In particular, a feed may be placed a focal distance away from a reflector, so that the resulting beam is narrow. If the feed is slightly misplaced, a slightly wider unfocused beam may be generated, which can have advantages, up to the point that the energy in the broader beam is insufficient to counteract the high path loss and shadowing effects associated with mmW wave propagation.

It is possible to provide antenna arrangements which support communication using frequencies where free space path loss is of significance and narrow beams are used to overcome such path loss occurs. Antenna arrangements may be such that they provide a field of view which facilitates establishment and maintenance of an effective communication link between, for example, a mmW static electronic device base station and a user with a desired level of reliability. An antenna reflector can be arranged such that it results in a narrow directed beam emanating from antenna apparatus. One possible such reflector arrangement comprises a parabolic reflector. Use of a parabolic reflector can ensure that any beam emanating from an antenna apparatus is narrow, as a result of the focusing induced by the parabolic reflector, and therefore the energy within the beam is concentrated. It will be appreciated that any appropriately shaped reflector may act to focus or concentrate a wave emanating from a feed, and that a parabolic reflector is one example of shaping which can focus a wave.

FIG. 1a and FIG. 1b illustrate example high gain mm-wave antenna solutions for 24.0-43.5 GHz New Radio (NR). The example antenna implementations illustrated comprise parabolic reflector antennas fed with a small antenna microstrip antenna array. Such antenna solutions can be supplied at relatively low cost and have a low power consumption compared to a large microstrip antenna array. The example arrangements shown in FIG. 1 are configured such that they provide, between 20 and 30 dB antenna gain. High antenna gain is a desirable feature in some radio coverage deployments since it can be used to increase coverage and radio performance of fixed wireless access (FWA) service and radio network spectral efficiency. The antenna apparatus 100 shown in FIG. 1a comprises generally a feed array 110 positioned such that a feed beam reaches a parabolic reflector 120 to generate a resulting high gain narrow beam. The Cassegrain type antenna apparatus 150 shown in FIG. 1b comprises generally a feed array 160 positioned such that a feed beam reaches a first reflector 170 and is then reflected towards a parabolic reflector 180 to generate a resulting high gain narrow beam.

FIGS. 2a to 2c are photographs of fixed wireless access devices for deployment at a location to provide a region of radio coverage. Devices such as those shown in FIGS. 2a to 2c may use parabolic reflector-based antenna arrangements such as those shown in FIG. 1a and FIG. 1b. Devices such as those shown in FIGS. 2a to 2c are generally cylindrical in shape, having a diameter of around 12 cm and are configurable to support install schemes both outdoors and indoors, and can be window mounted, wall mounted and/or pole mounted. In each instance, the device can provide 360 degree horizontal/azimuth plane high gain antenna beam coverage, such coverage may, in some arrangements, be achieved by rotating the mm-wave antenna apparatus with respect to the outer case, for example, by appropriate use of an electrical motor.

FIG. 3 illustrates schematically a plan view of antenna apparatus such as that shown in FIGS. 1a and 1b, located within a device such as that shown in FIGS. 2a to 2c. The device 300 is such that a narrow beam 310 emanates from it. It will be appreciated that it may be necessary to align the high gain antenna beam emanating from the antenna apparatus to provide reliable radio signal reception to another node in a communications network which emanates a radio frequency signal for communication 320. In the implementations shown, the high antenna gain provided by the antenna apparatus means the antenna beam is narrow. For antenna apparatus such as that shown in FIGS. 1a and 1b, the azimuth half power beam width (HPBW) is ˜6°. To be able to make use of the narrow antenna beam in a real-world deployment, systems and methods can be implemented align the narrow beam to point the radio signal in an appropriate direction to support communication between communicating nodes in a network.

Arrangements recognise that there can be issues resulting from mechanisms to support high gain beam alignment. In devices such as those shown in FIG. 2, mounting the antenna apparatus on a rotating platform results a fixed antenna and rotation mechanism, for example, an electrical motor. The rotation mechanism is configured to move the antenna apparatus in an azimuth plane as shown generally in relation to FIG. 3 to align the beam such that it is always positioned to transmit and receive a strong radio signal from a network user in its region of radio coverage. The alignment occurs as a result of a scanning method. According to a typical scanning method, the antenna beam is aligned by rotating the antenna apparatus within the device housing in pre-defined steps and measuring the received signal strength and quality from a user after each step. Once a 360° scan is completed, the position of at which the antenna receives the strongest signal can be determined and the antenna apparatus can be reoriented and locked to that best position.

Arrangements recognise that one problem associated with such a method of alignment of a narrow beam to support communication between nodes in a communication network is that signal strength can only be measured in relation to a particularly narrow sector at any given moment. There is therefore a need to measure many narrow sectors and implement many steps to achieve a full 360° coverage. In practice, a rotatable antenna apparatus needs to be stopped at each stepped position, since the signal strength and quality measurements recorded at each step need to represent an average taken over several samples. Such sampling occurs over a time period of several seconds. Moreover, at each step there is may also be a need to have a settling down period for a radio access network to adapt its beam steering and other radio parameters in order to obtain a reliable measurement at each step. As a result, beam alignment scans may be very slow. Slow and dense stepped beam alignment methods may result in associated issues such as: problems finding a radio signal; connection timeouts and/or undesirable handovers sub-6 GHz NR/LTE. Slow and unreliable antenna beam alignment can cause problems in relation to first time installation of a device at a site and in the case of realignment in the event of any change in radio environment.

Some Fixed Wireless Access (FWA) devices are such that they use multiple small antenna arrays which provide low or moderate gain and moderate beamwidth A. Each of the multiple small antenna arrays are arranged to point in a different direction to facilitate implementation of a 360° azimuth or wide (>120°) azimuth plane coverage. One example of a 5G mm-wave FWA device 400 utilising multiple small antenna arrays is shown schematically in FIG. 4. In the illustrated implementation, four small antenna arrays 410, 420, 430, 440 are provided and have a primary radiation direction offset with respect to an adjacent antenna array by 90 degrees. In order to “align” an antenna with a user emanating a signal 450, the signal strength of all four antenna arrays can be measured, for example, simultaneously, and the antenna of the four available antennas which is determined to provide the best signal strength is then selected for continued use at that time. It will be appreciated that such implementations require provision of multiple small antenna arrays and can make an antenna constellation within a coverage device very expensive. Furthermore, as can be seen schematically from FIG. 4, such an arrangement maybe such that there are areas X with low antenna gain coverage in between the antenna arrays.

Arrangements described recognise that it is possible to provide antenna arrangements which comprise components which may be reconfigurable with respect to one another such that they can support: (i) a wide beam mode in which they are operable to create a wide beam and (ii) a narrow beam mode in which the components are configured to support a narrow beam having high gain. According to some arrangements, the narrow beam mode may be supported by, for example, components of antenna apparatus which together form a parabolic reflector antenna such as those shown in FIG. 1a or 1b which can support a narrow beam with high gain. Some arrangements comprise a reconfigurable parabola antenna structure. Some arrangements recognise that a narrow beam second reflector parabola antenna apparatus such as those shown in FIGS. 1a and 1b may result in a narrow beam having an azimuth beamwidth of around 6° and if the components are rearranged or reconfigured and the parabolic reflector is unused, the antenna array feeding the main reflector may be such that a resulting wide beam has an azimuth beamwidth of around 70°.

Arrangements recognise that by providing mechanisms according to which the parabola antenna can be reconfigured, it is possible to offer a route by which alignment methods can be performed efficiently. In particular, it may be possible to implement an alignment method comprising steps of: recognising that a beam emanating from an antenna apparatus within a device requires alignment with another node in a communication network in order for the beam emanating from the antenna apparatus to support effective, reliable and/or efficient communication with that node. If a need to adjust alignment is recognised, components of the antenna apparatus within the device may be transformed, adjusted or reconfigured such that a wide beam mode of operation is supported. Whilst configured to operate in a wide beam mode, the apparatus may perform a coarse scan of a wide field of view. The antenna apparatus configured to generate the wide beam may be rotatable and the antenna apparatus may be rotatable or positionable relative to the fixed device housing, at two or more positions such that the wide beam generated by the antenna apparatus may be located to cover a different portion of the wide field of view. An assessment of radio signal strength and quality between the antenna apparatus and another node in the network can be made at each of the two or more positions. Once measurement has been made at each of the two or more positions, an assessment can be made of the position of the antenna apparatus which provides the best signal strength in wide beam mode. The components of the antenna apparatus within the device may then be transformed, adjusted or reconfigured such that a narrow beam mode of operation is supported. A fine resolution scan may then occur within the field of view which would be covered were the antenna apparatus in the position of the antenna apparatus determined to provide the best signal strength in wide beam mode. That is to say, a stepped narrow beam alignment scan, similar to that described in relation to a full 360 degree scan above, may be performed across the field of view of the antenna apparatus in the position of the antenna apparatus determined to provide the best signal strength in wide beam mode. At each step of the scan signal strength and quality measurements can be recorded, and those recorded measurements may represent an average taken over several samples in order to obtain a reliable measurement at each step. Once the stepped set of narrow beam measurements have been taken, a determination can be made of the position of the antenna apparatus which provides the best signal strength and quality in narrow beam mode and the narrow beam position which is determined to provide the best signal strength is then selected and implemented for continued use at that time.

In some arrangements, the coarse initial stepped scan may occur over an entire 360 degree field of view surrounding a fixed wireless access point device in a communications network. In some arrangements, the coarse scan may occur over a portion of the entire 360 degree field of view. That portion may, for example, comprise 270 degrees, 180 degrees or 90 degrees, depending upon the configuration or location of the device.

In some arrangements, the initial stepped scan may comprise at least two steps in which the antenna apparatus is rotated such that the wide beams emanating from the device are immediately adjacent in each step. The rotational positions may be selected such that the beams emanating do not overlap. In some arrangements, an initial coarse scan may occur across a selected wide field of view, in which the beams emanating do not substantially overlap. In the event that two or more adjacent positions of the antenna apparatus operating in wide beam mode are determined to support similar signal strengths and qualities in wide beam mode, a further wide beam scan may occur, with the antenna apparatus configured to operate in wide beam mode. That further scan may occur such that the rotational position of the antenna apparatus is selected so that the beam emanating from the device is directed towards the centre of the field of view of the combined field of view of the two or more adjacent positions of the antenna apparatus operating in wide beam mode. The measurements taken in that further scan may be compared with the measurements taken when in the two or more adjacent positions of the antenna apparatus operating in wide beam mode, and, if determined to be better, the narrow refining second stepped scan may occur over the range of field of view determined by the position of the antenna apparatus in the further initial scan.

In other words, arrangements recognise that it is possible to implement a two stage antenna beam alignment process. In step one, a fast and spare scan occurs. The fast and sparse scan uses antenna apparatus having a wide beam and occurs over, for example, a horizontal 360 degrees, to find the direction in which the strongest radio signal can be found. That sparse scan can occur relatively fast and can occur without dropping a connection.

In step two a fine scan over the narrower sector, defined by the result of the strongest radio signal found in step one, occurs. The fine scan occurs with the antenna apparatus in narrow beam mode. Narrow beam mode is used to perform the final beam alignment without dropping the connection or needing to handover.

Typically wide-beam mode may have a lower antenna gain (for example 10 dB lower) than the narrow beam configuration. Arrangements may also recognise that, in the event of a cell edge corner case where the radio signal strength is very low and the device cannot establish a connection with a user when in wide beam stage, it is possible to introduce a full 360 degree stepped alignment scan using the narrow beam in order to support antenna apparatus alignment.

FIGS. 5a and 5b illustrate schematically a two-phase alignment scan method of some arrangements.

FIG. 5a illustrates a network access node, for example a fixed wireless access point device 510 suitable for deployment at a location, for example, customer premises. The device 510 comprises components configured to support a wide antenna beam 520, as shown in FIG. 5a, and a narrow beam 530, as shown in FIG. 5b. The antenna apparatus is rotatable, so that the direction of the emanating beam 520; 530 can be adjusted, as shown by arrow 540. A network node to communicate with device 510 transmits a radio frequency signal 560. A fast scan for alignment purposes occurs using the antenna apparatus in wide beam mode, as shown in FIG. 5a. Once the general direction of signal 560 is identified, a fine scan can occur, using the narrow beam mode of the apparatus, as shown in FIG. 5a.

Various reconfigurable parabolic reflector antenna structures which can support the two-phase alignment process described are presented in detail below. It will be appreciated that provision of a reconfigurable antenna apparatus allows for a cost effective implementation of hardware required to support a two-phase alignment process. The antenna apparatus described are such that they are configurable to provide a wider feeder antenna beam during a first phase of a beam alignment process, and then a narrower antenna beam during a second phase of the beam alignment process. Such a two-step process can help to mitigate some of the problems associated with existing alignment processes.

FIGS. 6a and 6b illustrate the main components of one possible example hardware implementation of reconfigurable antenna apparatus. The example antenna apparatus illustrated may be configured for use in a fixed wireless access point device configured for installation at customer premises.

The antenna apparatus 600 shown comprises a feed antenna array 610. In the example shown the feed array may comprise a 4×1 array of antenna elements. The antenna apparatus may also comprise a parabolic reflector 620 configured in combination with the feed array 610 to create a narrow beam 670 having an azimuth beamwidth of around 6° when the feeder antenna array 610 is pointing towards the parabolic reflector 620 as shown in FIG. 6a. Without the parabolic reflector, the feed array produces a beam 680 having an azimuth beamwidth of around 700 azimuth. If the antenna array is pointed away from the reflector, the array achieves this wider beam, as shown in FIG. 6b. The feed array 610 is held in position with respect to the reflector 620 by mounting arms 630. The feed array is rotatably mounted on the arms 630 to facilitate reconfiguration of the array 610 with respect to the reflector 620 to switch the antenna apparatus components between the relative positionings shown in FIGS. 6a and 6b. In wide beam state, shown in FIG. 6b, the feed antenna array is rotated 180° from the position shown in FIG. 6a, and points away from the parabola reflector and can be used with its inherent ˜70° azimuth beamwidth beam. When rotated through 180 degrees, the feed array 610 is directed to emanate energy directly towards the parabolic reflector 610, as shown in FIG. 6a, and thereby create a narrow, high gain beam. Rotation of the feeder antenna 610 on the mounting arms 630 can be implemented, for example, by means of an electrical motor (not shown) and an appropriate mechanical structure, for example the mounting arms 630, and electrical assembly (not shown) to enable the reconfiguration of the antenna apparatus. It will be appreciated that the entire antenna apparatus 600 way be rotatably mounted on a platform 650, to facilitate the stepped alignment method described above. The platform 650 is located within a device enclosure. The antenna apparatus 600 can be configured to be rotatably mounted within the enclosure of a device. The rotation of the platform 650 with respect to the enclosure can be effected by a motor (not shown).

FIGS. 6c and 6d are schematic representations of configurations of components within a device enclosure 660 and resulting beam patterns of a hardware antenna according to the examples shown in FIGS. 6a and 6b respectively. FIG. 6c corresponds to the configuration of components shown in FIG. 6a and results in a narrow antenna beam. FIG. 6d corresponds to the configuration of components shown in FIG. 6b and results in a wide antenna beam.

Various possible alternative antenna and hardware arrangements exist for creating a reconfigurable antenna apparatus switchable between a first configuration in which wide beam operation is supported and a second configuration in which narrow beam operation is supported.

FIG. 7 illustrates the main components of one possible example hardware implementation of antenna apparatus which can support the alignment methodology of some described arrangements. The antenna apparatus 700 comprises two antennas. A first feeder antenna 710 is arranged on mount arms 720 and a signal emanating from the feed antenna 710 is directed towards a parabolic reflector 730 and is reflected to form a narrow beam emanating from the antenna apparatus 700. A wide beam antenna is also provided, 740. The wide beam antenna 740 operates without a reflector. Both the wide beam antenna 740 and narrow beam antenna formed by feeder antenna 710 and reflector 730, are mounted on the same rotatable platform 750.

FIGS. 8a and 8b are schematic representations of configurations of antenna components within a device enclosure and resulting beam patterns. FIG. 8a corresponds generally to the arrangement of components shown in FIG. 6c in which an antenna feed 810 produces a feed beam 820 which is directed towards a parabolic reflector 830 to produce a narrow beam 840. FIG. 8b corresponds to an arrangement similar to that shown in FIG. 6d, wherein the reflector is reoriented by 180 degrees to allow a wide beam to emanate from the device.

FIGS. 9a and 9b are schematic representations of configurations of antenna components within a device enclosure and resulting beam patterns. FIG. 9a corresponds generally to the arrangement of components shown in FIG. 6c in which a feed antenna 910 produces a feed beam 920 which is reflected off a parabolic reflector 930 to generate a narrow beam 940. FIG. 9b corresponds to an arrangement similar to that shown in FIG. 6d, wherein the reflector 930 is moved away from a position in which it can reflect a signal from the feed antenna 910 to allow a wide beam 950 to emanate from the device.

FIGS. 10a and 10b are schematic representations of configurations of antenna components within a device enclosure and resulting beam patterns. FIG. 10a comprises a Cassegrain-type of parabola antenna in which an antenna feed 1010 directs a signal 1015 toward a first reflector 1020, which directs the signal to a main parabola reflector 1030 to result in a narrow, high gain beam 1040 emanating from a device enclosure 1050. FIG. 10b show corresponds to an arrangement in which the first reflector 1020 is moved and the antenna feed 1010 therefore is configured to produce a wide beam 1060 to emanate from the device enclosure 1050.

FIGS. 11a and 11b are schematic representations of configurations of antenna components within a device enclosure and resulting beam patterns. FIG. 11a comprises a Cassegrain-type of parabola antenna in which an antenna feed 1010 directs a signal 1015 toward a first reflector 1020, which directs the signal to a main parabola reflector 1030 to result in a narrow, high gain beam 1040 emanating from a device enclosure 1050. FIG. 11b show corresponds to an arrangement in which the first reflector 1020 is flipped or rotated 90 degrees and no longer reflects the feeder antenna beam towards the parabola reflector 1030 and the antenna feed 1010 therefore is configured to produce a wide beam 1060 to emanate from the device enclosure 1050.

A person of skill in the art would readily recognize that steps of various above-described methods can be performed by programmed computers. Herein, some embodiments are also intended to cover program storage devices, e.g., digital data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable digital data storage media. The embodiments are also intended to cover computers programmed to perform said steps of the above-described methods.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

Although embodiments of the present invention have been described in the preceding paragraphs with reference to various examples, it should be appreciated that modifications to the examples given can be made without departing from the scope of the invention as claimed.

Features described in the preceding description may be used in combinations other than the combinations explicitly described.

Although functions have been described with reference to certain features, those functions may be performable by other features whether described or not.

Although features have been described with reference to certain embodiments, those features may also be present in other embodiments whether described or not.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. An apparatus, comprising antenna apparatus components reconfigurable between:
(i) a mode of operation which supports a radio communication beam having a first beamwidth; and
(ii) a mode of operation which supports a radio communication beam having a second beamwidth;
wherein the first beamwidth is several times the width of the second beamwidth;
and wherein the apparatus further comprises an assembly configured to adjust a direction of transmission of at least one of the radio communication beams generable by the apparatus
and wherein the antenna apparatus components comprise:
an antenna feed;
at least one reflector configured to reflect a beam receivable from the antenna feed; and
a positioning assembly, configured to control the relative positions of the antenna feed and the reflector;
wherein the positioning assembly is configured to reconfigure the relative positions of the antenna feed and reflector from a configuration which supports a radio communication beam having the first beamwidth and in which the at least one reflector is prevented from reflecting the beam receivable from the antenna feed; to a configuration which supports a radio communication beam having the second beamwidth and in which the reflector is arranged to reflect the beam receivable from the antenna feed.

2. An apparatus according to claim 1, wherein the first beamwidth is an order of magnitude greater than the width of the second beamwidth.

3. An apparatus according to claim 1, wherein the antenna apparatus components used to support the radio communication beams having the first and second beamwidth comprise common antenna apparatus components.

4. An apparatus according to claim 3, wherein the common components are physically reconfigurable to effect the switch between the first and second beamwidth.

5. An apparatus according to claim 1, wherein the at least one reflector comprises a parabolic reflector.

6. An apparatus according to claim 5, wherein the at least one reflector comprises a first reflector configurable to reflect a beam receivable from the antenna feed toward the parabolic reflector.

7. An apparatus according to claim 1, wherein the assembly comprises a mount to which the antenna apparatus components are mounted to be rotatable about an axis, such that the radio communication beam creatable by the components is adjustable.

8. A method, comprising:
determining that a radio communication beam supportable by an antenna apparatus according to claim 1 requires aligning with a further radio communication beam;
performing two or more first signal measurements across a first field of view using the antenna apparatus, the first signal measurements comprising a position of the radio communication beam supportable by the antenna apparatus within the first field of view and an indication of a characteristic of a communication link supportable by the radio communication beam supportable by the antenna apparatus and the further radio communication beam in that position;
determining, from the first signal measurements, the position at which the characteristic indicates a communication link supportable by the radio communication beam supportable by the antenna apparatus and the further radio communication beam is best;
reconfiguring the antenna apparatus from a mode of operation which supports a radio communication beam having a first beamwidth to a mode of operation having a second beamwidth, wherein the first beamwidth is several times the width of the second beamwidth;
performing two or more second signal measurements across a second field of view using the antenna apparatus, the second signal measurements comprising a position of the radio communication beam supportable by the antenna apparatus within the second field of view and an indication of a characteristic of a communication link supportable by the radio communication beam supportable by the antenna apparatus and the further radio communication beam in that position; wherein the second field of view is determined by the position at which the characteristic of a communication link supportable by the radio communication beam supportable by the antenna apparatus and the further radio communication beam is best whilst in the mode of operation which supports a radio communication beam having the first beamwidth;
determining, from the second signal measurements, the position at which the characteristic of a communication link supportable by the radio communication beam supportable by the antenna apparatus whilst in the mode of operation which supports a radio communication beam having the second beamwidth and the further radio communication beam is best; and
aligning the radio communication beam having the second beamwidth supportable by the antenna apparatus to that position.

9. A method according to claim 8, wherein the second signal measurements comprise a series of stepped signal measurements, wherein each second signal measurement comprises a measurement relating to a radio communication beam having a sector of the second field of view covered by a second beamwidth adjacent to another sector of the second field of view covered by a second beamwidth and at which a different second signal measurement is made.

10. A method according to claim 8, wherein the first signal measurements comprise a series of stepped signal measurements, wherein each first signal measurement comprises a measurement relating to a radio communication beam having a sector of the first field of view covered by a beamwidth adjacent to another sector of the first field of view covered by a beamwidth and to which a different first signal measurement applies.

11. A method according to claim 10, wherein the second signal measurements comprise a series of stepped signal measurements, wherein each second signal measurement comprises a measurement relating to a radio communication beam having a sector of the second field of view covered by a second beamwidth adjacent to another sector of the second field of view covered by a second beamwidth and at which a different second signal measurement is made.

12. A method according to claim 8, wherein if determining, from the first signal measurements, the position at which the indication of a characteristic of a communication link supportable by the radio communication beam supportable by the antenna apparatus is best reveals no maximum or no signal is detected; the two or more second signal measurements are performed across the first field of view.

13. A method according to claim 8, wherein the first field of view comprises one of: a 360 degree field of view or 180 degree field of view in an azimuth.
